(19) United States
(12) Patent Application Publication
(10) Pub. No.: US 2017/0093329 A1
(43) Pub. Date: Mar. 30, 2017

(54) ARRAY POWERED SOLAR TRACKING SYSTEM

(71) Applicant: SolarCity Corporation, San Mateo, CA (US)

(72) Inventor: Soren Jensen, Corte Madera, CA (US)

(21) Appl. No.: 14/981,661

(22) Filed: Dec. 28, 2015

Related U.S. Application Data
(60) Provisional application No. 62/233,974, filed on Sep. 28, 2015.

(51) Int. Cl. H02S 20/32; H02S 40/38; H02S 40/30

(52) U.S. Cl. CPC H02S 20/32; H02S 40/30; H02S 40/38

(57) ABSTRACT

A self-powered solar tracker array system and related method, where a torque tube supporting a plurality of strings of photovoltaic (PV) modules, a DC drive motor with a motor controller circuit, and a drive assembly is capable to rotate the torque tube with torque generated by the drive motor, where the power for operating the drive motor is taken from electricity generated by the PV modules. The system can include a battery to provide a power source for rotating the torque tubes when the PV modules are not generating electricity.

### CROSS-REFERENCE TO RELATED APPLICATION

This claims the benefit of U.S. Provisional Patent Application No. 62/233,974 (Attorney Docket Number P184-1PUS), entitled “ARRAY POWERED SOLAR TRACKING SYSTEM,” filed on Sep. 28, 2015, which is herein incorporated by reference in its entirety.

### TECHNICAL FIELD

The present disclosure relates to solar tracking systems, and in particular, to systems for powering a single-axis solar tracker without the need for separate grid power.

### BACKGROUND OF THE INVENTION

Solar trackers are used to rotate photovoltaic (PV) modules to keep them perpendicular to the direct rays of the sun. Keeping the PV modules, as part of an array, at this orientation increases or optimizes the amount of energy that can be generated by the array, because energy generated by the array drops off with the cosine of the angle of incidence of solar rays on the surface of the array. Although trackers add an additional cost per watt over fixed ground-mount systems, the cost is typically recouped on arrays of one megawatt or larger.

In a single-axis tracker, photovoltaic modules are suspended above the ground in one or more horizontal rows, connected to a beam known as a torque tube. The torque tube is attached to a drive mechanism actuated by a controller to incrementally rotate the photovoltaic array in place over the course of the day to maintain a constant angle with the sun as the sun progresses through the sky.

Because tracker arrays require very little post installation maintenance, the viability of these projects often turns on the projected rate of return derived from comparing the fixed value of the energy generated over the lifetime of the system versus the upfront costs of installation. In a multi-megawatt project, cost reductions of pennies per watt can be the difference between a project being viable or too expensive. Therefore, tracker designers are always seeking innovations to lower installation and hardware costs.

### BRIEF SUMMARY OF THE INVENTION

The present invention relates to solar tracking systems and systems for powering a single-axis solar tracker without the need for separate grid power, particularly taking advantage of the availability of electrical power from the photovoltaic (PV) modules local to each photovoltaic array. The ability to draw power for movement of a tracker array directly from the energy locally collected by the PV modules of the same tracker array provides for several advantages relating to the infrastructure and reduction of excess complexity, stemming from the relatively efficient arrangement of system components. Moreover, the amount of power drawn from the PV modules of the tracker array does not adversely affect the amount of electricity generated by the tracker array to be provided as a power source. The consumption of energy needed to move the PV modules of the tracker array is about 0.1% (or less) of the energy produced by the tracker array. Moreover, power consumed for moving the tracking array is limited to the duration of time needed for a discrete movement of a torque tube, so any relative drain on the energy produced by a given tracker array is insignificant.

There are several different drive systems that can be used for rotating a torque tube of a solar tracker array. Some rely on individual motors driving each torque tube in the array. Others use one or more central drive systems that interconnect multiple torque tubes with a single drive gear (e.g., worm gear, or jack screw type gear) to rotate them all in unison.

Because single axis tracker systems rely on motors, they require their own power to operate. Therefore, when installing a traditional tracker array, power lines must be buried or mounted in raceways around the array site with an electrical tap at each torque tube to provide persistent power to the motor and motor controller to enable the motor to carry out the rotation algorithm and for stowing purposes. Mounting or burying these power lines adds an extra layer of cost, time, and complexity to the installation, in particular in areas where the ground is rocky or unstable. This also requires an interface to grid power that allows the array to draw power as well as to feed it to the grid. Because the grid power is alternating current (AC), each motor control circuit must further include a power rectifier to convert the grid power to direct current (DC) to power the motor. Over the expected twenty to thirty year life of the array, those components are subject to failure from years of dissipating heat. This will create additional maintenance costs that will erode the array owner's return on investment.

Various embodiments of the present invention ameliorate these issues with a novel power circuit that taps into the DC power generated on each torque tube to power a DC motor and drive circuit. Various embodiments may also rely on a small energy storage device to enable the circuit to power the DC motor when system is not generating energy (i.e., at night, during cloudy conditions, etc.).

In many aspects, the present disclosure is advantageous for a solar tracking array system in that the amount of wiring required for powering and operating components of the solar tracking array system are reduced. Such wiring can be copper-based, aluminum-based, or the like. Solar power sites, particularly industrial-scale solar power sites, can cover a large area, up to greater than five hundred acres. The provision of electrical power directly at each drive motor of a given tracking array from the connected PV modules of that tracking array significantly minimizes the wiring required to connect the tracking arrays to one or more power substations, a centralized power source, or grid power. Several advantages can be had by minimizing the amount of wiring needed between tracking arrays at a solar power site. For example, the amount of electricity lost due to the resistance of wiring can be significantly reduced. Also, the cost and labor involved in laying down wiring, or burying wiring in trenches, is reduced, which carries the further advantage of reducing the amount of wiring exposed to the elements or at risk of damage. In addition, tracking is not dependent on grid power, thus the tracking procedure avoids issues regarding grid failure.

### BRIEF DESCRIPTION OF THE DRAWINGS

Illustrative aspects of the present disclosure are described in detail below with reference to the following drawing figures. It is intended that that embodiments and figures disclosed herein are to be considered illustrative rather than restrictive.

FIG. 1 is a schematic illustration of a solar tracking array system, according to embodiments of the disclosure.

FIG. 2 is a schematic side view illustration of a solar tracking array unit for a solar tracking array system, according to embodiments of the disclosure.

FIG. 3 is a schematic cut-away view of a motor for a solar tracking array unit, according to aspects of the disclosure.

FIG. 4 is a schematic representation of an electrical combiner box for a solar tracking array unit, according to aspects of the disclosure.

FIG. 5 is a diagram for a control circuit for a solar tracking array unit, according to aspects of the disclosure.

FIG. 6 is a block diagram showing function and control of a solar tracking array unit, according to aspects of the disclosure.

### DETAILED DESCRIPTION OF THE INVENTION

Throughout this description for the purposes of explanation, numerous specific details are set forth in order to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

The present system provides for a self-powered, solar tracker array system designed to provide electrical power to a motor controlling the tracking motion of the array system, the power being diverted from the PV modules of the array system.

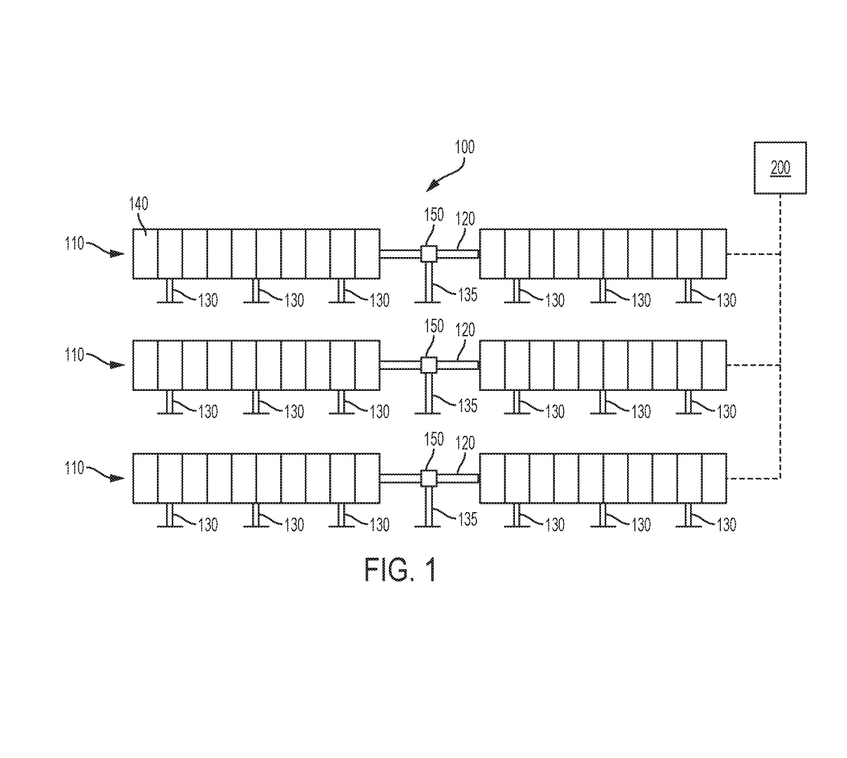

FIG. 1 is a schematic illustration of solar tracking array system 100. In particular, FIG. 1 shows solar tracking array system 100 having single-axis tracker arrays 110 according to various embodiments of the invention. Solar tracking array system 100 illustrates three rows of tracker arrays 110. Each tracker array row includes torque tube 120, support piles 130, and photovoltaic (PV) modules 140 (alternatively referred to as solar panels) which are mechanically coupled to respective torque tubes 120.

Individual tracker arrays 110 also include respective tracker motor housings 150. In the example of FIG. 1, tracker motor housings 150 are located in the middle of each tracker array 110, supported on primary pile 135. It can be appreciated that in various embodiments, the motor within motor housing 150 may be located on primary pile 135 at either end, or in between the middle and either end of tracker array 110. In some embodiments, motor housing 150 can be located on one or more support piles 130. In some aspects, support pile 130 and primary pile 135 can have a similar construction. In other aspects, primary pile 135 can be configured to specifically support motor housing 150 while support piles 130 are configured to support PV modules 140 via torque tube 120.

FIG. 1 further shows optional substation 200, where substation 200 can be a relay and control point for one or more tracker arrays 110. In some embodiments, substation 200 is connected to devices for measuring local environmental conditions. Substation 200 can process the measured data and determining whether there is an external risk to one or more tracker arrays 110 that would meet control guidelines (e.g. sensory indication of a flood or earthquake proximate to tracker arrays 110) or a threshold for moving one or more tracker arrays 110 to a stowing position. In some aspects, substation 200 can send instructions directly to motor controllers of one or more tracker arrays 110. In some aspects, substation 200 can relay signals to motor controllers of one or more tracker arrays 110, where subsequently, control logic at motor controllers of one or more tracker arrays 110 can determine whether or not to move a given tracker array 110 to a stowing position.

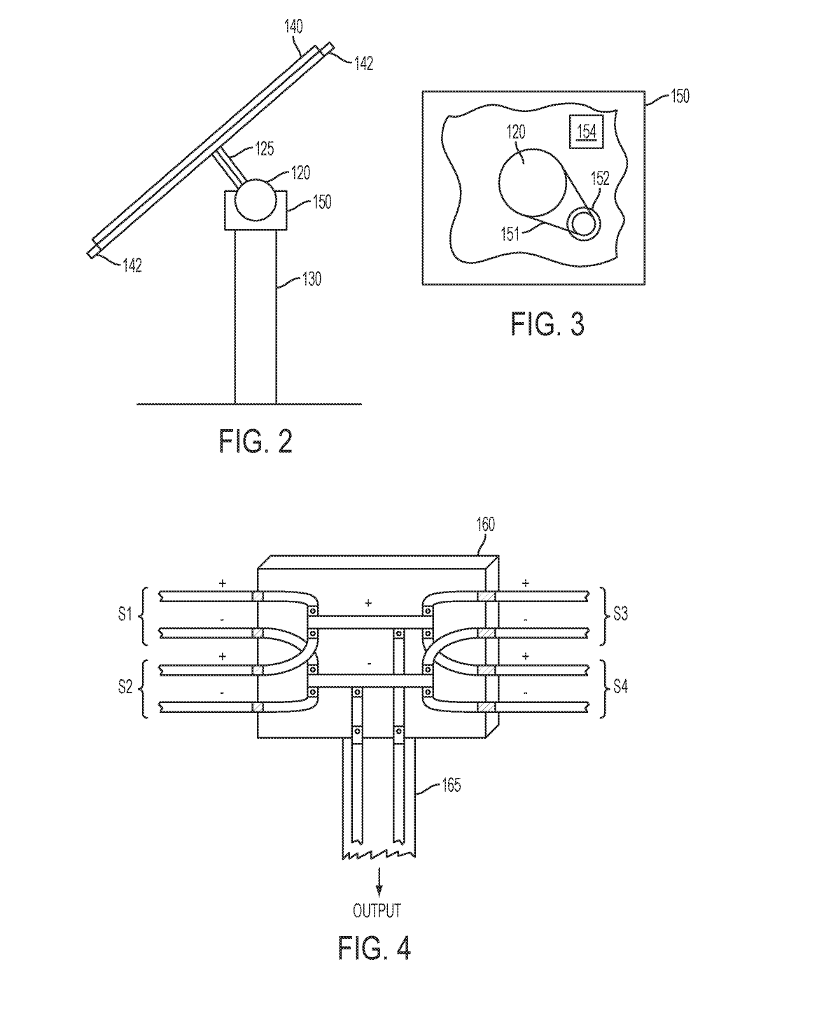

FIG. 2 shows a side view of an exemplary tracker array 110. Tracker array 110 includes PV module 140 connected to torque tube 120 by arm 125. Motor housing 150 houses the drive motor, motor control circuit, and drive assembly used to translate torque from the motor into rotation of torque tube 120. In various embodiments, torque tube 120 will rotate through a range of angles through the course of each day to track the progression of the sun through the sky. Torque tube 120 and support piles 130 have sufficient structural strength to support PV modules 140 including, but not limited to, 60-cell PV modules, 72-cell PV modules, 80-cell PV modules, 92-cell PV modules, and other commercial and industrial PV modules known in the industry.

FIG. 3 is a cut-away view of motor housing 150. In the example of FIG. 3, torque tube 120 passes through the center of motor housing 150. Drive motor 152 is coupled to torque tube 120 via drive assembly 151, which can be a chain. It should be appreciated that in various embodiments, a different drive mechanism could be used for drive assembly 151, such as a ring gear, a belt, or other suitable drive assembly for translating drive motor 152 torque into rotation of torque tube 120. In some embodiments, a combination of drive assembly 151 structures can be used to mechanically connect drive motor 152 with torque tube 120. Motor controller 154 is also shown, where motor controller 154 can be a non-transitory computer-readable medium (e.g. a PCB) capable of receiving, processing, and sending instructions for moving drive motor 152, and by extension, torque tube 120 and PV modules 140.

Typically, for a single-axis form of tracker array 110, torque tube 120 is oriented in a North-South line such that PV modules 140 can rotate from East to West to track the sun from sunrise through sunset. In many aspects, motor controller 154 or some other circuit in motor housing 150 can control the rotation of torque tube 120 in accordance with a control algorithm. Also, rotation of torque tube 120 may be dynamic, in response to prevailing conditions. For example, in the event of detected high winds, motor controller 154 may deviate from a standard tracking algorithm to implement a stowing algorithm where torque tube 120 is rotated to reduce and/or minimize wind-induced loads. Typically, though not necessarily, stowing consists of rotating torque tube 120 until PV module 140 panels are parallel with the ground. This enables air to flow under and over PV module 140 panels evenly without creating a moment on torque tube 120 that could damage tracker array 110, tracker drive motor 152, and/or drive assembly 151. As seen in FIG. 1, motor housing 150 can also be structurally supported by a local support pile 130. One or more support piles 130 and/or primary pile 135 may also structurally support torque tube 120.

The local supply of power provided by PV modules 140 provides a further advantage over receiving power via a power substation, a centralized power source, or grid power in that drive motor 152 is not vulnerable to being unpowered due to a black-out, brown-out, or physical interruption of power from such remote power supplies. Thus, drive motor 152 can move tracker array 110 to a stowed position to account for high winds, regardless of the status of a connection to remote power supplies.

In some aspects, sensors for measuring and detecting the speed, direction, and intensity of wind can be located on one or more tracker arrays 110. In other aspects, sensors for measuring and detecting the speed, direction, and intensity of wind can be located as independent anemometer stations of solar tracking array system 100, coupled with one or more tracker arrays 110 to communicate information regarding local wind and environmental conditions. In various embodiments, solar tracking array system 100 can have one, five, ten, twenty, or more than twenty anemometer stations, with the number of anemometer stations selected and positioned as appropriate for the landscape and area of the PV module array site. Based on data received from such sensors, motor controller 154 within motor housing 150 can provide instruction to drive motor 152 to adjust the angle at which tracker array 110 positions PV modules 140. Additionally or alternatively, substation 200 can receive data from such sensors and further provide instruction to one or more tracker arrays 110, specific to control drive motor 152 to adjust the angle at which individual tracker arrays 110 positions respective PV modules 140.

In many aspects, motor controller 154 within operatively coupled to drive motor 152 can be programmed to cause rotation of torque tube 120 according to a control algorithm that tracks progression of the sun through the sky. In some aspects, the control algorithm can be an astronomical algorithm selected to track the sun, which can be selected as appropriate for a given latitude of solar tracking array system 100, and which can adjust a rate of motion based on the time of year. In other aspects, the algorithm can be a timing algorithm, moving tracker array 110 based on the time of day. In some aspects, the algorithm can be configured to track the sun accounting for the location of tracker array 110 in relation to other components of solar tracking array system 100, and/or geographic features of the array site. In some respects, motor controller 154 local to tracker array 110 and coupled to drive motor 152 can be referred to as a control processor.

In some aspects, tracker array 100 can further include one or more photosensors 142, which in some aspects can be referred to as a light insulation sensor. Photosensor 142 can measure the amount of light incident on PV modules 140 of tracker array 100. The light level data measured by photosensor 142 can be relayed to motor controller 154 and/or substation 200. Photosensor 142 can be located on a top edge, a bottom, edge, or a side edge of PV module 140, or on a combination thereof. The data measured by photosensor 142 can be processed and analyzed by motor controller 154 as part of an optimizing or “hunting” algorithm, where the hunting algorithm is configured to control tracker array 110 to make incremental or relatively minor adjustments in order to move tracker array 110 to a position that receives the most solar radiation at any given time.

In further aspects, the control algorithm can be a combination of any or all of an astronomical algorithm, a timing algorithm, a low precision algorithm, or a hunting algorithm, as described herein.

In many embodiments, the consumption of energy needed to move the PV modules of tracker array 110 is about or less than 0.1% of the energy produced by the tracker array. Moreover, power consumed for moving the tracking array is limited to the duration of time needed for a discrete movement of a torque tube 120, so any relative drain on the energy produced by a given tracker array 110 is minimal relative to power collected and produced by tracker array 110.

FIG. 4 illustrates combiner box 160 for use with solar tracking array system 100, where one or more combiner boxes 160 can be a part of solar tracking array system 100. In tracker array 110, as in other residential and commercial solar systems, individual PV modules 140 are wired together serially, forming electrical strings, with the voltages adding until they reach somewhere between six hundred and one thousand volts (600-1000 V), depending on the capacity of the wires and other components. Therefore, a single torque tube 120 may be carrying several electrical strings, depending on the number of PV modules in each row of tracker array 110. For simplicity of illustration, each torque tube 120 in FIG. 1 has only a single row of PV modules 140, however, it should be appreciated that in practical application, each torque tube 120 could support two, three, or four or more rows of PV modules 140, with reach row increasing the number of strings for given torque tube 120.

In the example of FIG. 4, combiner box 160 is combining the output of four electrical strings (S1, S2, S3, & S4) into a single pair of positive and negative elements for electrical output. The respective positive and negative lines coming from each string are joined together on a bus bar or other common conductor that is capable of accommodating with the additive current.

Regardless of the number of strings coming into combiner box 160, combiner box 160 consolidates the electrical outputs of the electrical strings into a single electrical output, particularly to a single positive-negative pair of high voltage output lines 165. Output lines 165 are then fed to an inverter. In some embodiments, the inverter can also be located on torque tube 120 or elsewhere local on tracker array 110. In other embodiments, the inverter can be centralized (for example as substation 200), receiving electrical output from multiple tracker arrays 110. Whether the inverter is located on torque tube 120 or located centrally, the output of any given tracker array 110 can run down one of support piles 130 or 135 into a buried conduit. Electricity from the conduit can route to one or more substations 200 of solar power array site, and/or to a central power station of solar power array site, where the electrical output all tracker arrays 110 are joined and can then be provided as a power source to an electrical grid.

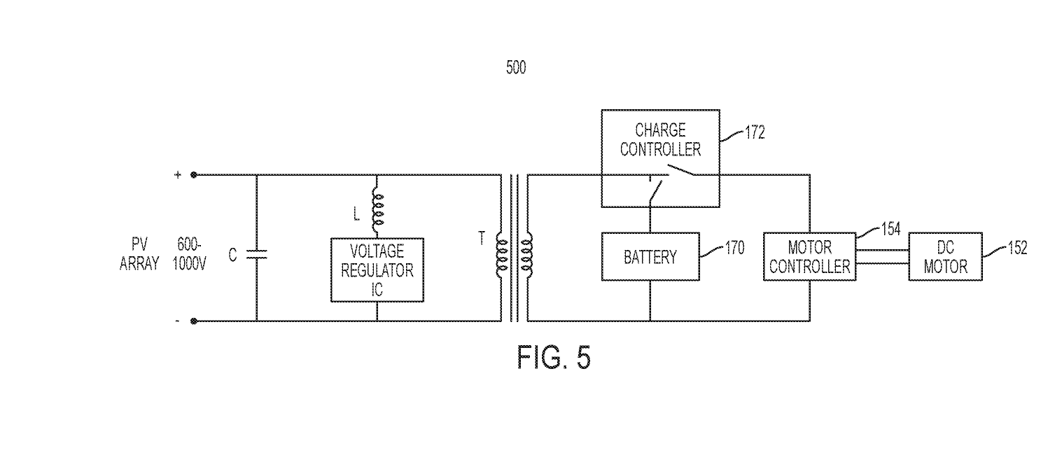

FIG. 5 illustrates control circuit 500 for providing power to drive motor 152 and motor controller 154 according to various embodiments of the invention. Control circuit 500 has a parallel tap to a high voltage DC power source of at least one string of a given tracker array 110. The voltage (typically 600-1000 V) is then stepped down using a circuit such as that shown in FIG. 5 to a voltage level such as 24 volts, 12 volts or 5 volts, depending on the voltage of drive motor 152. Without a voltage reducing element in control circuit 500, drive motor 152 risks being overloaded by the voltage generated by PV modules 140.

During operation, the high voltage current first charges capacitor C to the level of voltage on the DC lines. Inductor L and voltage regulator integrated circuit (IC) are wired in parallel with capacitor C and high voltage side of transformer T. Low voltage side of transformer T supplies low voltage current to DC drive motor 152. The specific level of output voltage of the transformer T will be tuned to match the voltage requirement of drive motor 152.

In some aspects, additional electrical components can be coupled to drive motors 152 and PCBs within motor housings 150 or elsewhere along the circuit. Such components can include a protection diode, surge protectors, or, as shown, charge controller 172. Charge controller 172 may be desirable and/or necessary to ensure that lower voltage outputs (e.g., 24-volt, 12-volt, 5-volt, etc.) are used to power controller circuit 500 without overloading drive motor 152 or motor controller 154 with the high voltage received from tracker array 110.

Because circuit 500 of FIG. 5 is the only circuit providing power to drive motor 152, without a further power source, drive motor 152 will only operate when PV module 140 PV modules are generating electricity. However, it may be necessary to rotate torque tube 120 at other times when PV module 140 PV modules may not be generating a sufficient amount of electricity, such as at dusk, dawn, under precipitation or cloudy conditions, or at night. It may be necessary to rotate torque tube 120 at times with minimal or no sunlight, for example, in response to hazardous wind conditions. For this reason, various embodiments of the invention may include an energy storage device such as battery 170 on the lower voltage side of the transformer T. Battery 170 can be wired in parallel with motor controller 154, as part of the configuration to power drive motor 152. In this manner, when tracker array 110 is not providing any power, battery 170 can still power the DC drive motor 152.

In some embodiments, drive motor 152 is required to operate for a minute or less, hence, a relatively small capacity battery may be used to power DC motor 152. For example, battery 170 having a capacity of 6,000 mW may be sufficient to power a 24-volt DC drive motor 152 for the time necessary to stow or un-stow tracker array 110. Alternatively, battery 170 can be configured to store enough charge to power drive motor 152 for at least one or two days without being further charged by PV modules 140 or a remote power supply. In many aspects, battery 170 can store sufficient charge to at least power drive motor 152 to move torque tube 120 and tracker array 110 to and from a stowing position for at least several days.

While some embodiments of the present disclosure are directed to controllers that are local to each tracker array 110, other embodiments of the present disclosure can include a centralized controller. For example, a solar power array site can have one or more control substations 200 distributed around the site, each substation 200 being connected to one or more tracking arrays 110, relaying either or both of control instructions and signals from sensors of solar tracking array system 100. In some aspects, substations 200 can process signals based on measurements from sensors of solar tracking array system 100 and provide movement instructions to one or more tracker arrays 110 accordingly, for example to have one or more tracker arrays 110 move to a safe configuration, such as a stowing configuration or position. In other aspects, substations 200 can relay signals based on measurements from sensors of solar tracking array system 100 to one or more tracking arrays 110, where control logic at motor controller of tracker array 110 can process the received signals and then determine what the next movement for tracker array 110 should be, for example, moving tracker array 110 to a safe configuration, such as a stowing configuration or position, or continuing motion according to a control algorithm.

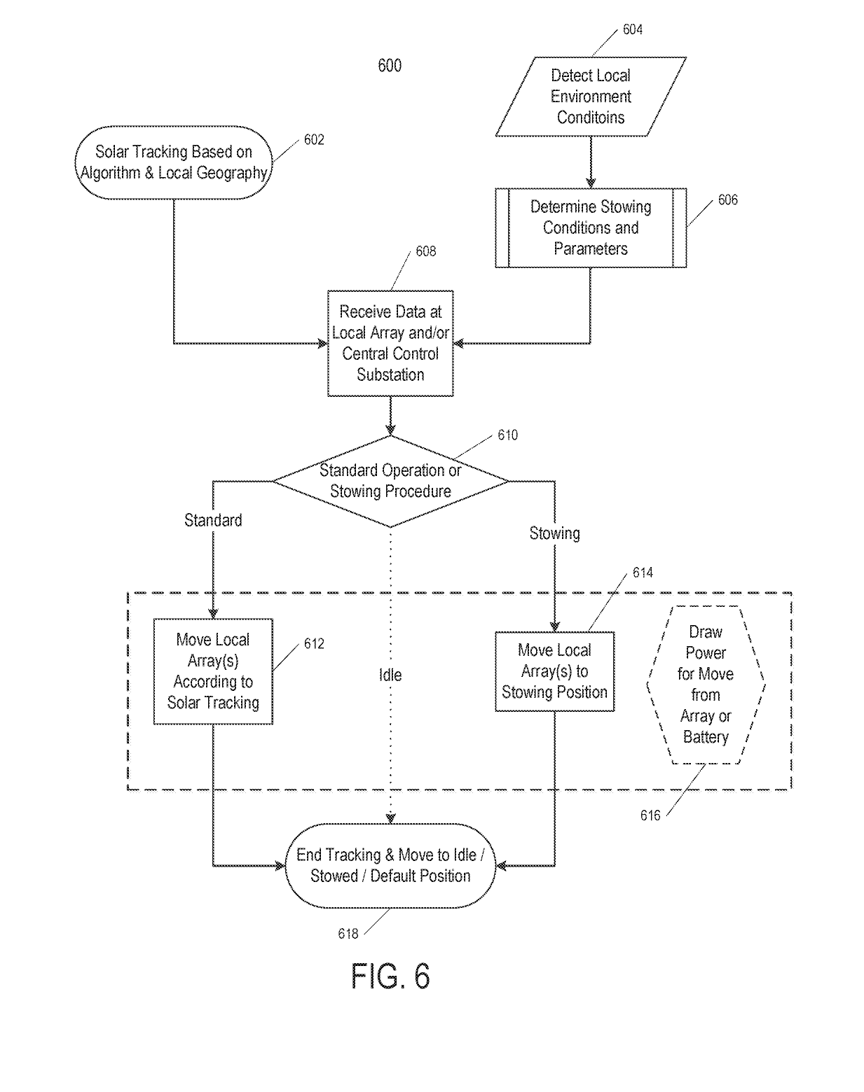

FIG. 6 presents block diagram 600 showing function and control of at least one solar tracking array unit, which represents in part a method of operation for solar tracking array system 100. At block 602, a solar tracking array system is initialized, where the solar tracking of the system is based on a control algorithm. In aspects, the control algorithm can be an astronomical algorithm, which in further aspects, can be modified to account for latitude and/or longitude of a given solar tracking array site. In some aspects, the control algorithm can be modified to account for variances in local geography of the solar tracking array site, (e.g., mountains that partially block sunlight from an eastern and/or western horizon) such that the array tracking system has a daily starting and/or daily ending position selected to maximize exposure to sunlight.

In combination with the control algorithm, at block 604, sensors of a solar tracking array system can detect local environmental conditions relevant to the operation and safety of units for an array tracking system. In various aspects, sensors connected to the array tracking system can include anemometer stations, thermometers, and/or humidity sensors. In further aspects, data relating to local environmental conditions can be provided by warning signals provided to the system from alternative sources, such as storm warning signals or other such local weather alerts.

At block 606, the detected and/or measured local environmental conditions can be analyzed, processed, and/or compared with established conditions and parameters relating to whether photovoltaic array units should be moved to a stowing position. The process of determining whether photovoltaic array units should be moved to a stowing position can be a continuous, repeated, intermittent, and/or iterative process, such that instructions, warnings, calculated parameter-based signals, externally received signals, or the like can be communicated to the overall array system and individual array units on a regular or constant basis. Accordingly, as the local environmental conditions change, the connected photovoltaic array units can receive status updates throughout the day and night.

At block 608, data received from both the control algorithm and measured/detected local environmental conditions is processed by a controller, which can include at least one processor coupled to memory for storing instructions. The processor can be configured to execute instructions for providing movement to one or more aspects of the array system. In some embodiments, the instructions can be for operation of a single tracking array, such that the single array motor controller can adjust position for the local conditions specific to that tracking array. In other words, while a plurality of tracking arrays may receive the same signals relaying local environmental conditions, a particular array may be operated to adjust position and stow according to a different set of thresholds than other tracking arrays. In other embodiments, a centralized control station (or substation) can send further instructions to one or more tracking arrays for individually directing movement for each tracking array to account for local environmental conditions, control algorithm, or modifications of the control algorithm specific to individual tracking arrays. In further embodiments, one or more tracking arrays may be controlled by a combination of both local processing and centralized processing instruction.

At block 610, a determination is made as to whether one or more tracking arrays should move according to a standard routine or a stowing routine. In some aspects, such as at night when there is no solar radiation or in conditions where there are no problematic local environmental conditions, control of the one or more tracking arrays can be in an “Idle” state, proceeding to block 618 as described below.

If following a “Standard” routine, at block 612, the one or more tracking arrays move according to a solar tracking process, generally following the control algorithm to track and optimize incident solar radiation on the one or more tracking arrays. In various aspects, the control algorithm for any given tracking array can include motion of the tracking array as determined by an astronomical algorithm, such that the tracking array PV modules follow the path of the sun with an optimal or near-optimal progression. In other aspects, a relatively low precision algorithm can be used to control the motion of a tracking array, in conditions where a processor or a physical component of the tracking array may be old, damaged, compromised, and a less precise or intensive control algorithm can be used as an interim functionality until the tracking array can be repaired and/or upgraded. In further aspects, geographic features of the terrain surrounding or proximate to the array site can lead to one or more tracking arrays having a control algorithm modified relative to an astronomical algorithm, such that the PV modules of the tracking array have starting, stopping or other positions which attempt to optimize collection of solar radiation in a manner that accounts for geographic obstructions. Upon ending of a “Standard” routine, e.g., which can occur when the sun sets, the one or more tracking arrays can proceed to block 618 as described below

If following a “Stowing” routine, at block 614, the one or more tracking arrays move according to a solar tracking process, generally diverging from a control algorithm for tracking solar radiation, and instead moving to a configuration or orientation that can mitigate or reduce any adverse effect from local environmental conditions on the tracking array. In some embodiments, the control algorithm can be locally controlling a single tracking array according to instructions on a processor located at the tracking array, where the stowing action is individualized to the specific tracking array. In other embodiments, the control algorithm can be controlling a single tracking array in combination with one or more other tracking arrays according to instructions on a processor located at a centralized control station (or substation), where the stowing action can coordinate between one or more tracking arrays (e.g. directing wind through an array site by orientation of a plurality of tracking arrays), move any given tracking array according to an individualized set of instructions for the specific tracking array, or apply a combination thereof. In further embodiments, one or more tracking arrays may be controlled by a combination of both local processing and centralized processing instruction. Upon ending of a “Stowing” routine, the one or more tracking arrays can proceed to block 618 as described below

While in either of a Standard or a Stowing routine, further data and signals are received at block 608. Thus, the decision point of block 610 can switch between operating according to a Standard routine of block 612 of a Stowing routine of block 614, and a tracker array can be adjusted accordingly. In some aspects, control of whether a system transitions away from a Stowing routine can be based on the signals relating to local environmental conditions being within a tolerable or safe range for a specific period of time. Thus, for example, a temporary lull in high intensity winds will not lead to a tracking array to move out of a stowing position if the lull in high intensity winds does not last for a sufficient period of time—indicating that the high intensity winds have ceased or passed. In other aspects, data received at block 608 can be overridden by control instructions provided by an operator or through a separate automated command system. This may occur if sensors for detecting local environmental conditions are unavailable, broken, or otherwise erroneous, the one or more tracking arrays can be instructed to move to a stowing position or to move according to a control algorithm independent of the data otherwise received (or not received) from such sensors.

As seen in block 616, each of the one or more tracking arrays can be powered at least in part by both the Standard routine of block 612 and the Stowing routine of block 614 can be powered by drawing power for movement of a tracker array from the same tracker array itself. A motor controlling rotation of the tracker array can use power generated by PV modules of a tracker array. In some aspects, the voltage of the power generated by the PV modules of the tracker array needs to be stepped-down such that the motor controlling the rotation of the tracker array can operate without being overloaded. In some embodiments, one or more electrical strings originating from the PV modules of the tracking array can be combined into a unified output, from which electricity can be drawn to power the motor controlling the rotation of the tracker array. In alternative aspects, electricity can be drawn from any of the electrical strings before reaching a combiner box that unifies the electrical output of the tracker array, in order to power the motor controlling the rotation of the tracker array.

Further, an energy storage device, such as a battery, can also be electrically connected to the motor controlling the rotation of the tracker array. Under conditions where the PV modules of the tracker array are not generating electricity, power can be drawn from the energy storage device in order to power the motor controlling the rotation of the tracker array such that the tracker array can change position in response to instructions or signals received (e.g. stowing instructions). In some aspects, the energy storage device can be a rechargeable battery, that is recharged by drawing power from the electricity generated by the tracker array itself, tapping into the electrical outputs of the PV modules in a manner similar to how the motor controlling the rotation of the tracker array can directly draw power from the tracker array.

In various embodiments, tapping the electricity generated by the tracker array PV modules involves connecting parallel positive and negative sources from an electrical string to a drive motor and/or control circuit for the drive motor.

At block 618, a termination and/or reset point, the tracker array system can be idle. The tracker array system can reach the idle state after progressing through either or both of the Standard routine or the Stowing routine. In some aspects, when in an idle state, the tracker array can be oriented in a stowing position as a resting or default position. In other aspects, the tracker array can have a default position that is equivalent to the starting position of the tracker array for progressing through a daily control algorithm.

It is understood that while the present disclosure is directed to solar tracker array systems that move along a single axis, the diversion of power to operate a local drive motor can be applied to solar tracker array systems that move along two axes or three axes.

In some embodiments, the present disclosure is directed to a method and/or a corresponding system for powering a tracker controller that includes the steps of creating parallel positive and negative connections to at least one string of PV modules on a torque tube of a solar tracker; connecting the parallel positive and negative connections to a voltage reducing circuit; connecting an output of the voltage reducing circuit to a controller printed circuit board (PCB); connecting an energy storage device in parallel with the controller PCB; connecting a DC motor to the energy storage device; and connecting a mechanical linkage between the motor and the torque tube that is operable to rotate the torque tube based a command to the motor from the controller PCB.

In some aspects of the method or corresponding system, the energy storage device can draw electricity from the at least one string of PV modules to recharge the energy storage device. In other aspects, the DC motor device can similarly draw electricity from the at least one string of PV modules to rotate the torque tube. In some aspects, the method can further include connecting a charge controller to the voltage reducing circuit to prevent overloading either or both of the energy storage device or the controller PCB. In some aspects, the controller PCB can be configured to rotate the torque tube according to a control algorithm. In some aspects, the controller PCB can be further configured to receive signals based on detected environmental conditions and to rotate the torque tube to a stowing position.

In other embodiments, the present disclosure is directed to an array powered system for a solar tracker controller having a parallel tap into the positive and negative wires of at least one string of a photovoltaic array attached to a rotating torque tube; a voltage reducing circuit connected to the positive and negative wires of the at least one string via the parallel tap; a controller PCB connected to an output of the voltage reducing circuit; an energy storage device also connected to the output of the voltage reducing circuit; and a DC motor mechanically linked to the torque tube and operable to rotate the torque tube in accordance with an instruction by the controller PCB and drawing power from either the energy storage device or the output of the voltage reducing circuit. In some aspects, the energy storage device can be a battery. In some aspects, the controller PCB can be referred to as a motor controller.

In further embodiments, the present disclosure is directed to a self-powered solar tracker array having a torque tube supporting a plurality of strings of PV modules, a DC drive motor, a drive assembly configured to rotate the torque tube with torque generated by the drive motor, a motor controller circuit, a DC-to-DC power circuit (which can be referred to as a transformer circuit) adapted to reduce a voltage on at least one string to supply the reduced voltage to the DC drive motor and the motor controller circuit, and an energy storage device operable to store energy from the DC-to-DC power circuit and to supply energy to the DC drive motor and motor controller circuit when the plurality of strings of PV modules are not generating energy.

In some aspects, the drive assembly can include any one of a chain, a ring gear, a belt, or a combination thereof. In other aspects, the energy storage device can draw electricity from the at least one of the plurality of strings of PV modules to recharge the energy storage device. In some embodiments, the solar tracker array further includes an connection to a substation, where the motor controller circuit is configured to receive instructions from the substation. In such embodiments, more than one solar tracker array can be connected to the substation, and receive instructions coordinated to manage control of a plurality of solar tracker arrays. In some aspects, the solar tracker array can further include a charge controller as part of the DC-to-DC power circuit, configured to prevent overloading either or both of the energy storage device or the motor controller circuit. In other aspects, the motor controller circuit can be configured to rotate the torque tube according to a control algorithm. In other aspects, the motor controller circuit can also be configured to receive signals based on detected environmental conditions and to rotate the torque tube to a stowing position. In some aspects, the solar tracker array can further include one or more photosensors mechanically coupled to at least one PV module and configured to provide light level data to the motor controller circuit.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The embodiments of the present inventions are not to be limited in scope by the specific embodiments described herein. For example, although many of the embodiments disclosed herein have been described with reference to single axis trackers, the principles herein may be equally applicable to other types of trackers. Indeed, various modifications of the embodiments of the present inventions, in addition to those described herein, will be apparent to those of ordinary skill in the art from the foregoing description and accompanying drawings and claims. Thus, such modifications are intended to fall within the scope of this invention. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, this disclosure should be construed in view of the full breath and spirit of the embodiments of the present inventions as disclosed herein and claimed below.

What is claimed is:

1. An array powered system for a solar tracker controller comprising:
an array of photovoltaic modules supported by a torque tube and including at least one string of electrically interconnected modules;
a parallel power tap into the at least one string;
a voltage reducing circuit for reducing voltage of the parallel tap;
a motor controller connected to an output of the voltage reducing circuit;
a battery connected to the output of the voltage reducing circuit;
a DC motor mechanically linked to the torque tube and operable to rotate the torque tube in accordance with an instruction by the motor controller, and drawing power from either the battery or the output of the voltage reducing circuit.

2. The array of claim 1, wherein the battery draws electricity from the at least one of a photovoltaic array to recharge the battery.

3. The array of claim 1, further comprising an connection to a substation wherein the motor controller is configured to receive instructions from the substation.

4. The array of claim 1, further comprising a charge controller as part of the voltage reducing circuit, configured to prevent overloading either or both of the battery and the motor controller.

5. The array of claim 1, wherein the motor controller is configured to rotate the torque tube according to a control algorithm.

6. The array of claim 1, wherein the motor controller is configured to receive signals based on detected environmental conditions and to rotate the torque tube to a stowing position based at least in part on said detected conditions.

7. A self-powered solar tracker array comprising:
a torque tube supporting a plurality of strings of photovoltaic modules;
a DC drive motor;
a drive assembly configured to rotate the torque tube with torque generated by the drive motor;
a motor controller circuit;
a transformer circuit comprising a transformer adapted to reduce voltage of current generated by at least one string power the DC drive motor and the motor controller circuit; and
an energy storage device operable to store energy from the transformer and to supply the energy to the DC drive motor and motor controller circuit when the plurality of strings of photovoltaic modules are not generating energy.

8. The solar tracker array of claim 7, wherein the drive assembly comprises any one of a chain, a ring gear, a belt, or a combination thereof.

9. The solar tracker array of claim 7, wherein the energy storage device draws electricity from the at least one of the plurality of strings of photovoltaic modules to recharge the energy storage device.

10. The solar tracker array of claim 7, further comprising an connection to a substation wherein the motor controller circuit is configured to receive instructions from the substation.

11. The solar tracker array of claim 7, further comprising a charge controller as part of the transformer circuit, configured to prevent overloading either or both of the energy storage device or the motor controller circuit.

12. The solar tracker array of claim 7, wherein the motor controller circuit is configured to rotate the torque tube according to a control algorithm comprising an astronomical algorithm.

13. The solar tracker array of claim 7, wherein the motor controller circuit is configured to receive signals based on detected environmental conditions and to rotate the torque tube to a stowing position.

14. The solar tracker array of claim 7, further comprising one or more photosensors mechanically coupled to at least one photovoltaic module and configured to provide light level data to the motor controller circuit.

15. A system for powering a tracker controller, comprising:
parallel positive and negative connections connected to at least one string of photovoltaic modules on a torque tube of a tracker array;
a voltage reducing circuit connected to the parallel positive and negative connections;
a controller PCB, connected to an output of the voltage reducing circuit;
an energy storage device connected in parallel with the controller PCB;
a DC motor connected to the energy storage device; and
a mechanical linkage between the motor and the torque tube that is operable to rotate the torque tube based a command to the motor from the controller PCB.

16. The system of claim 15, wherein the energy storage device draws electricity from the at least one string of photovoltaic modules to recharge the energy storage device.

17. The system of claim 15, wherein the DC motor device draws electricity from the at least one string of PV modules to rotate the torque tube.

18. The system of claim 15, further comprising a charge controller connected to the voltage reducing circuit configured to prevent overloading either or both of the energy storage device or the controller PCB.

19. The system of claim 15, wherein the controller PCB is configured to rotate the torque tube according to a control algorithm comprising an astronomical algorithm.

20. The system of claim 15, wherein the controller PCB is configured to receive signals based on detected environmental conditions and to rotate the torque tube to a stowing position.
